(19) United States
(12) Patent Application Publication
(10) Pub. No.: US 2024/0241285 A1
(43) Pub. Date: Jul. 18, 2024

(54) Geological Surface-Scanning Apparatus

(71) Applicant: PlotLogic Pty Ltd, Queensland (AU)

(72) Inventors: Andrew Job, Queensland (AU); Michael Edgar, Queensland (AU); Marina Auad, Queensland (AU); Matthew Garlan, Queensland (AU)

(73) Assignee: PlotLogic Pty Ltd, Queensland (AU)

(21) Appl. No.: 18/560,277

(22) PCT Filed: Jul. 18, 2022
(86) PCT No.: PCT/AU2022/050758

§ 371 Date: Nov. 10, 2023

(30) Foreign Application Priority Data
Jul. 19, 2021 (AU) 2021104296

(51) Int. Cl. G01V 8/18; E21B 49/00; G01V 8/14; G01V 8/16

(52) U.S. Cl. CPC G01V 8/18; E21B 49/00; G01V 8/14; G01V 8/16

(57) ABSTRACT

The present invention relates to a geological system. The system includes an apparatus for use when scanning an uneven geological surface and that need not contact the geological surface. The apparatus includes a light source for providing light. A reflector is provided for reflecting incident light onto the geological surface, and for reflecting reflected light from the geological surface. The apparatus also includes optical fibre means for receiving the reflected light from the reflector. The system includes moving means for moving the apparatus along the uneven geological surface during scanning. Advantageously, the apparatus does not require physical sampling of material along a hole, and may instead move along the hole at very fast speeds (typically up to between 2 to 4 m/s) whilst obtaining hyperspectral radiometric data. The apparatus may be low cost, and may include no radioactive materials, so that there is little concern or business interruption if it is lost down a hole.

### TECHNICAL FIELD

The present invention generally relates to a geological surface-scanning apparatus. The present invention has particular, although not exclusive application to mining.

### BACKGROUND

The reference to any prior art in this specification is not, and should not be taken as an acknowledgement or any form of suggestion that the prior art forms part of the common general knowledge.

In mining applications, elongate boreholes are formed and testing is undertaken to evaluate the material content along the borehole.

In practice, known testing equipment suffers drawbacks including being expensive which is undesirable when lost down the borehole, or requiring physical sampling of material along the borehole resulting in slow test times.

The applicant has perceived a need for an improved means for such testing.

### SUMMARY OF THE INVENTION

According to one aspect of the present invention, there is provided a geological system including:
an apparatus for use when scanning an uneven geological surface and that need not contact the geological surface, the apparatus including:
   a light source for providing light;
   a reflector for reflecting incident light onto the geological surface, and for reflecting reflected light from the geological surface; and
   optical fibre means for receiving the reflected light from the reflector; and
moving means for moving the apparatus along the uneven geological surface during scanning.

Advantageously, the apparatus does not require physical sampling of material along a hole, and may instead move along the hole at very fast speeds (typically up to between 2 to 4 m/s) whilst obtaining hyperspectral radiometric data. The apparatus may be low cost, and may include no radioactive materials, so that there is little concern or business interruption if it is lost down a hole.

The reflector may include a mirror. The mirror be obliquely oriented to the geological surface. The mirror may include a concave, spherical, parabolic or elliptical mirror. A beam of the incident light may diverge from the mirror to the geological surface. The mirror may include an optical mirror. The mirror may focus the reflected light onto, or proximal to, the optical fibre means.

The apparatus may include a window through which the incident and reflected light passes. The window may include infra-red (IR) grade fused silica. The direction of light from the light source and/or to the optical fibre means may be transverse the direction of light from the wall.

The optical fibre means may include an optical fibre bundle. The optical fibre means may have a limited acceptance angle.

The light source may include a halogen bulb, and preferably a quartz-halogen bulb. The light source may include another reflector, preferably being concave, elliptical, spherical or parabolic. The light source may have a focal point before the reflector. The light source may transmit light axially along a hole.

The apparatus may include a housing for housing the light source, reflector and optical fibre means. The housing may be environmentally sealed.

The apparatus may be less than 400 mm long, less than 100 mm wide, and/or less than 100 mm high.

The system may include a hole defining the geological surface.

The optical fibre means may extend along the hole. The system may further include a spectroradiometer located outside the hole for receiving a signal from the optical fibre means.

The system may be configured to continually scan the geological surface for spectra in the range 400 to 2500 nm.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of a geological surface-scanning apparatus scanning the wall of a borehole in accordance with an embodiment of the present invention; and

FIG. 2A is an exploded view of the geological surface-scanning apparatus of FIG. 1;

FIG. 2B is a plan view of the geological surface-scanning apparatus of FIG. 2A;

FIG. 2C is a side view of the geological surface-scanning apparatus of FIG. 2A;

FIG. 2D is a bottom view of the geological surface-scanning apparatus of FIG. 2A; and

FIG. 2E is an end view of the geological surface-scanning apparatus of FIG. 2A.

### DETAILED DESCRIPTION OF PREFERRED EMBODIMENTS

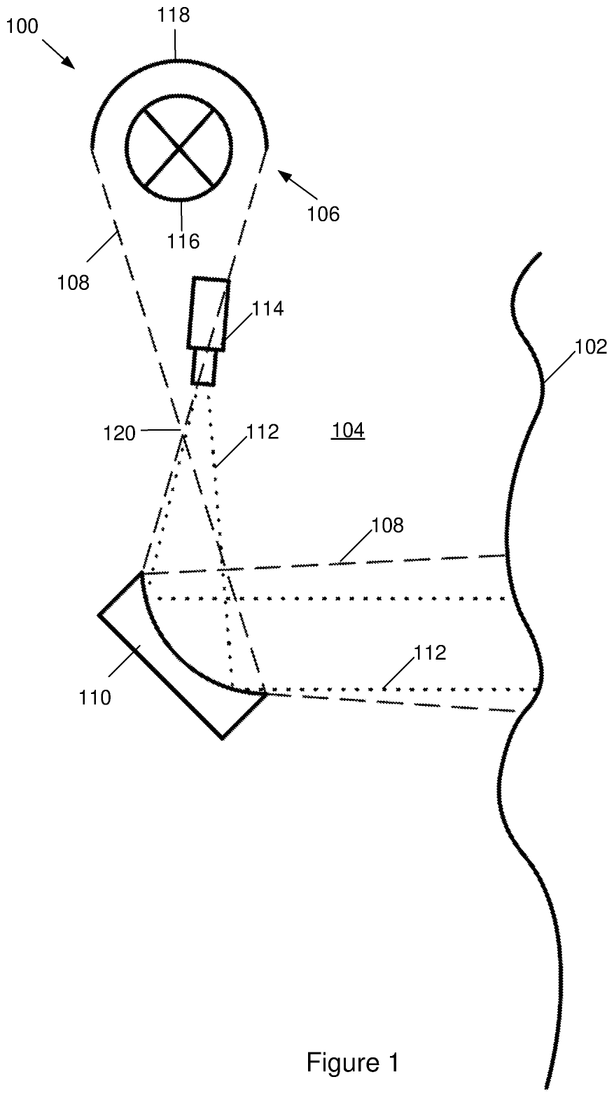

According to an embodiment of the present invention, there is provided a geological surface-scanning apparatus 100 for scanning an uneven wall 102 (i.e. geological surface) of a mining borehole 104, as shown in FIG. 1. The borehole 104 is up to hundreds of millimetres in diameter and tens of metres deep. The apparatus 100 is of lesser diameter than the pre-formed mining borehole 104 in which it is dangled and lowered during scanning, and need not contact the wall 102 although may bump into it from time to time.

The apparatus 100 includes a light source 106 for providing incident light 108. An optical mirror 110 (i.e. reflector) is provided for reflecting the incident light 108 (dashed lines), from the light source 106, onto the wall 102. The mirror 110 also reflects reflected light 112 (dotted lines) from the wall 102. The apparatus 100 further includes optical fibre means 114 for receiving the reflected light 112 (dotted lines) from the mirror 110.

Advantageously, the scanning apparatus 100 does not require physical sampling of rock material along the hole 104, and is instead moved along the hole 104 at very fast speeds (typically up to between 2 to 4 m/s) whilst obtaining hyperspectral radiometric data. The apparatus 100 is low cost, and includes no radioactive materials, so that there is little concern or business interruption if it is lost down the hole 104.

The mirror 110 is obliquely oriented to the downwardly extending wall 102. The mirror 100 may be a concave mirror, a spherical mirror at an angle, an off-axis parabolic mirror or an off-axis elliptical mirror.

The distance from the light source 106 to the mirror 110 is chosen to both maximise the light illuminating the wall 102 and so that the illuminated area of the wall 102 is always slightly larger than the area from which optical fibre means 114 receives the reflected light 112, as the distance between the apparatus 100 and the wall 102 varies. A beam of the incident light 108 slightly diverges from the mirror 110 to the wall 102.

The mirror 110 focuses the reflected light 112 onto, or proximal to, the optical fibre means 114 which ensures that the area of the wall 102 from which the optical fibre means 114 receives the reflected light 112 is constant, or only slowly expanding, as the distance between the apparatus 100 and the wall 102 varies.

The light source 106 includes a quartz-halogen bulb 116. The light source 106 further includes a backing reflector 118 to transmit light 108 axially along the hole 104. The reflector 118 is concave, elliptical, spherical or parabolic so that the light source 106 has a focal point 120 before the mirror 110.

The optical fibre means 114 includes an optical fibre bundle with a limited acceptance angle defined by its numerical aperture.

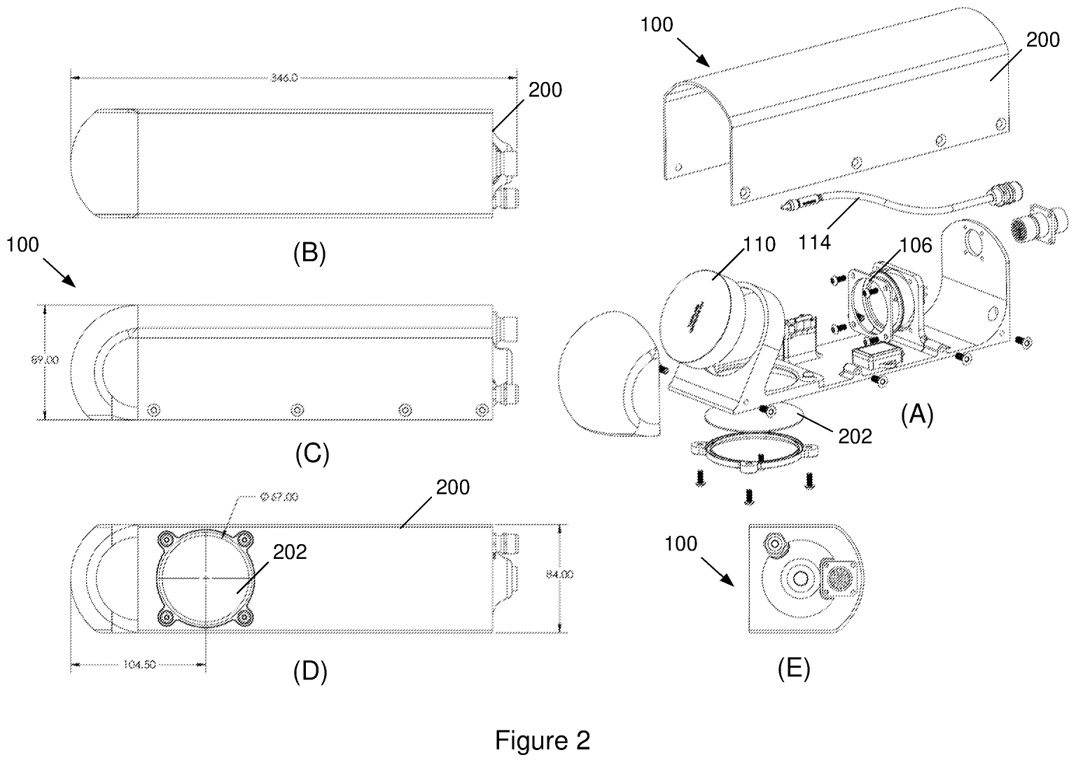

FIG. 2A shows an exploded view of the geological surface-scanning apparatus 100.

The apparatus 100 includes a multi-part housing 200, or shell, for housing the light source 106, mirror 110 and optical fibre means 114. Furthermore, the apparatus 100 includes a window 202 through which the incident light 108 and reflected light 112 passes. The window 202 includes infra-red (IR) grade fused silica. The housing 200 is environmentally sealed to protect the internal components from harsh environmental conditions.

FIGS. 2B to 2E show that the portable apparatus 100 is less than 400 mm long, less than 100 mm wide, and less than 100 mm high, making it extremely compact.

The apparatus 100 forms part of an overall geological surface-scanning system including the borehole 104. Motorised moving means is provided for moving the apparatus 100, dangled by the elongate optical fibre means 114, along the hole 104 to scan the wall 102.

The optical fibre means 114 extends down along the borehole 104. The system further includes a spectroradiometer located on the ground surface, outside the hole 104, for receiving a signal from the optical fibre means 114. The system is configured to continually scan the wall 102 for spectra in the range 400 to 2500 nm, using a combination of visual and infrared spectroscopy to measure a vertical profile of the distribution mineral ores and waste materials within the hole 104.

The apparatus 100 allows high-quality spectral information to be retrieved from below the ground surface to relatively large depths and be received by the optical-fibre fed spectroradiometer, without significant signal loss. Closely matching the illuminated area on the wall 102 with that from which the fibre-optic means 114 receives reflected light 112, allows high quality spectra to be acquired irrespective of the distance from the apparatus 100 to the scanned surface of the wall 102. There is no requirement that the surface of the wall 102 being measured be smooth.

The Applicant has measured variations of the intensity of the light less than a factor of 3 for distances from the optical axis of the apparatus 100 to the surface of the wall 102 varying from the radius of the optic to more than the radius of the hole 104. One test case involved 140 mm over 100 mm of travel or more for 70% of the available space. The combination of a large peak signal with a small variation with distance, allows spectra with very high signal-to-noise ratio to be acquired irrespective to the variation of the distance from the apparatus 100 to the scanned surface of the wall 102. As high-quality spectra can be acquired over the full usable range of the radius of the hole 104, neither complex mechanisms for automatically varying the focus of the optics nor maintaining a constant separation between the apparatus 100 and the scanned surface of the wall 102 are required. The distance between the apparatus 100 and scanned surface of the wall 102 does not even have to be measured. The optical design of the apparatus 100 is simple and requires no moving parts or adjustment. This allows the apparatus 100 to have a robust, light-weight, and compact configuration and be operated remotely with full automation.

The apparatus 100 is small relative to the distance over which it can acquire high quality spectra. The apparatus 100 is attached to a deployable cable, of order centimetre thickness, allowing for easy handling and is capable of reaching tight areas, with difficult or no human access.

With varying distance between the moving apparatus 100 and the scanned surface of the wall 102, the constant matching of the illuminated area of the wall 102 with the area from which the fibre-optic means 114 receives reflected light 112 minimises the variation of the intensity of the reflected signal. The use of the same optic to both shape the illuminating beam 108 and focus the reflected light 112 onto the optical-fibre means 114 allows larger optics to be used, while still maintaining a compact design. This maximises the amount of light illuminating the surface, which produces high signal-to-noise ratios in the reflected spectra. A single optic also allows constant alignment between the illuminating and reflected beams 108,112 with varying distance between the apparatus 100 and the scanned surface of the wall 102, without the need of a mechanically complex alignment system that separate optics would require.

The optical design imposes no requirements on the environmental housing 200, other than the use of an optically-suitable window 202, so the housing 200 can be fabricated from a wide variety of materials, depending on the application. Therefore, the environmentally sealed housing 200, combined with a fused silica window 202, allows the apparatus 100 to be used in an extensive range of harsh physical and chemical environments.

A person skilled in the art will appreciate that many embodiments and variations can be made without departing from the ambit of the present invention.

The apparatus 100 can be used to scan any surface where access is limited, and contact sampling techniques are not practical or sufficiently fast enough. Other applications include underground caverns/stopes with the apparatus 100 mounted to a UAV or ground vehicle; scanning up underground holes for underground mining; scanning inside of dumps of stockpiles (after drilling a bore hole) to determine the material contents; scanning underwater e.g., reefs or seabed for mineral composition.

Variations in the optical arrangement also include:
the mirror 110 can be replaced by a combination of an angled plane mirror and lens;
light sources 106 and optics with various diameters and optical properties can be combined to allow the apparatus 100 to be used at both significantly smaller or larger distances;
another fibre-optic bundle could be used as the light source 106 within the apparatus 100, with either a quartz-halogen bulb or super-continuum laser illuminating the end of this second fibre bundle on the surface;
a bifurcated fibre-optic bundle could be used, with one branch connected to the spectroradiometer and the other to a light source 116, both mounted on the ground surface outside the hole 104; and
a different fibre-optical bundle and window 202 could be used to extend the low end of the spectral coverage of the apparatus 100 to ultra-violet wavelengths.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A geological system including:
an apparatus for use when scanning an uneven geological surface and that need not contact the geological surface, the apparatus including:
a light source for providing light;
a reflector for reflecting incident light onto the geological surface, and for reflecting reflected light from the geological surface; and
optical fibre for receiving the reflected light from the reflector; and
a motorized apparatus for moving the apparatus along the uneven geological surface during scanning.

2. A geological system as claimed in claim 1, wherein the apparatus does not require physical sampling of material along a hole, and instead moves along the hole whilst obtaining hyperspectral radiometric data.

3. A geological system as claimed in claim 1, wherein the reflector includes a mirror.

4. A geological system as claimed in claim 3, wherein the mirror is obliquely oriented to the geological surface.

5. A geological system as claimed in claim 3, wherein the mirror includes a concave, spherical, parabolic or elliptical mirror.

6. A geological system as claimed in claim 3, wherein a beam of the incident light diverges from the mirror to the geological surface.

7. A geological system as claimed in claim 3, wherein the mirror includes an optical mirror.

8. A geological system as claimed in claim 3, wherein the mirror focuses the reflected light onto, or proximal to, the optical fibre.

9. A geological system as claimed in claim 1, wherein the apparatus includes a window through which the incident and reflected light passes.

10. A geological system as claimed in claim 9, wherein the window includes infra-red (IR) grade fused silica.

11. A geological system as claimed in claim 1, wherein the direction of light from the light source and/or to the optical fibre is transverse the direction of light from the wall.

12. A geological system as claimed in claim 1, wherein the optical fibre includes an optical fibre bundle.

13. A geological system as claimed in claim 1, wherein the optical fibre has a limited acceptance angle.

14. A geological system as claimed in claim 1, wherein the light source includes a halogen bulb, and preferably a quartz-halogen bulb.

15. A geological system as claimed in claim 1, wherein the light source includes another reflector, preferably being concave, elliptical, spherical or parabolic.

16. A geological system as claimed in claim 1, wherein the light source has a focal point before the reflector.

17. A geological system as claimed in claim 1, wherein the light source transmits light axially along a hole.

18. A geological system as claimed in claim 1, wherein the apparatus includes an environmentally sealed housing for housing the light source, reflector and optical fibre.

19. A geological system as claimed in claim 1, wherein:
the apparatus is less than 400 mm long, less than 100 mm wide, and/or less than 100 mm high; and
the system is configured to continually scan the geological surface for spectra in the range 400 to 2500 nm.

20. A geological system as claimed in claim 1 including a hole defining the geological surface, the optical fibre extending along the hole, the system further including a spectroradiometer located outside the hole for receiving a signal from the optical fibre.

21-23. (canceled)
